(19) United States
(12) Patent Application Publication
(10) Pub. No.: US 2008/0175011 A1
(43) Pub. Date: Jul. 24, 2008

(54) Cable Lighting System

(76) Inventor: Mark Joseph, Aspen, CO (US)

Correspondence Address: GLENN L. WEBB;GLENN L. WEBB P.C., P.O BOX 951, CONIFER, CO, 80433, US

(21) Appl. No.: 11/625,191

(22) Filed: Jan. 19, 2007

(51) Int. Cl. F21V 21/16

(52) U.S. Cl. 362/407

(57) ABSTRACT

A suspended cable lighting system that is pre assembled and uses reels to house and tension the cable. This allows a user to quickly and easily assemble a lighting system for positioning of decorative or utility lighting fixtures without technical knowledge or tools. The system provides conductors which provide both power and support to a plurality of lighting fixtures, which may be suspended between opposing or adjacent walls, thereby creating various angles at which the lighting fixtures may be directed. The reel ratcheting assembly allows quick and simple tensioning of the conductors, and allows a user to relax the tension to gain access to the lighting fixtures for removal or repositioning without the use of tools.

### FIELD OF THE INVENTION

The present invention relates generally to lights and light fixtures. More specifically, it relates to a suspended cable and reel assembly that allows a user to quickly and easily install a lighting system for positioning of decorative or utility lighting fixtures.

### BACKGROUND OF THE INVENTION

Overhead lighting systems typically suspended from above such as by a ceiling fixture or by track lighting systems. Cable lighting systems have recently been developed to provide both power and support by conductors stretched across a plane bounded by two walls. These systems have become popular due to their simplicity, their functionality and their ability to place lamps suspended in areas that would normally be difficult to light. These systems allow a user to set up a suspended lighting system with a number of components and modify that system on demand. These cable lighting systems have also become commonplace in the United States and other countries for both utility and decorative lighting.

Most of theses systems are tensioned using multiple turnbuckles at each end of the conductors. One of these systems is disclosed in U.S. Pat. No. 5,158,360, issued to Banke. This system uses insulated cables stretched overhead between walls. The system is installed by common wall fasteners such as screws or sheetrock fasteners. The tension in these cables are adjusted by manually adjusting turnbuckles on either end. These systems require careful alignment of the attachment points and conductor cables on opposing walls. It is difficult to accomplish accurate alignment and consistent tensioning between the two conductors and thereby avoid an uneven plane. Fastening the cables securely and independently to varied surfaces is also difficult. This difficulty in turn may cause the lighting fixtures to be positioned at an undesired angle.

Another disadvantage of the system disclosed in U.S. Pat. No. 5,158,360 is the difficulty in modifying the arrangement of lighting fixtures once the system has been assembled. The tensioning method described above will often require the user to climb a ladder to reach the height of the conductor plane, and therefore be limited in movement for repositioning the lighting fixtures. The fixtures themselves are firmly held in place by cable clamps on both conductors, and are not retained once released, which requires the user to support the weight of the fixture until he or she can reposition the ladder at the desired location.

Other systems have tried to overcome these disadvantages by allowing the fixture to slide along the horizontal plane. One such system is disclosed in U.S. Pat. No. 5,440,469. This system, however, requires the use of rigid cylindrical conductors, that must be coupled together to reach the desired length, and do not allow the user to position the system between walls or other surfaces that are not parallel to each other.

Another such system is disclosed in U.S. Pat. No. 6,536,925. This system uses a separate supporting method and a plurality of S-hooks to achieve the desired movement. The disadvantages of this system are obvious, and include the appearance of unnecessary slack at the ends of each conductor, and the absence of any method for retracting and storing the unnecessary slack. This system also includes the limited ability to position the direction of the lamps once suspended from the cable assembly.

Another disadvantage of the prior art is the complexity of the hardware required for installation. One such system is disclosed in U.S. Pat. No. 6,244,733. This system requires multiple points of mounting on both the horizontal and vertical room surfaces. This system also limits the flexibility of the lighting system arrangement by imposing a rigid supporting method and heavy lighting fixtures and supports.

Another such system is disclosed in U.S. Pat. No. 5,340,322. This system also uses a rigid support and conductive member, which in turn also requires more support members and limits the options for the user to position the lighting fixtures. This system also has the disadvantage of not allowing the plane to be positioned between two room surfaces that are not parallel to each other.

In most cases, these prior systems require complicated mounting procedures using tools and an experienced installer. Licensed electricians are often needed to install the hard wired components safely. They require considerable mechanical skill in installation and maintenance. A need presently exists for a system that can be easily installed with little mechanical aptitude.

### SUMMARY OF THE INVENTION

The present invention solves these problems and others by providing a cable lighting system that can be easily installed with little mechanical ability or tools. The cable lighting system can be installed in any location that has opposing walls or even adjacent walls. The cable lighting system provides an integrated preassembled lighting system that can be installed straight from the packaging without assembly or modification.

The cable lighting system of a preferred embodiment of the present invention provides a preassembled system that has the cables, anchoring systems, a tensioning system, electrical transformer and lighting fixtures already assembled. The user simply anchors a plaque holding one end of the cables to a first surface, the opposing end of the cables are held by a plaque to a second surface. Then the user adjusts the tension in the cables without tools, adjusts the position of the lighting fixtures by sliding and aiming them to the desired orientation and connects the power cord to an electrical outlet.

The cable lighting system of a preferred embodiment provides a cable tensioning system that independently adjusts the tension in each cable. This allows the system to be installed at an angle or on uneven surfaces.

The cable lighting system of a preferred embodiment incorporates the tensioning system within the housing of one of the anchoring systems. This provides a clean and elegant look the cable lighting system. The electrical transformer may be mounted within the housing as well.

In a preferred embodiment of the cable lighting system, the tensioning system includes cable reels mounted by way of independent ratchet mechanisms to each of the cables. The cables are pre wound onto the reels and pull out for installation. The reels are then turned to tension the cables independently. This allows the tension in each cable to be independently adjusted until the appropriate tension in each cable has been reached and maintained.

A preferred embodiment of the cable lighting system of the present invention provides an electrical transformer to create a low voltage system. The transformer can be mounted within a housing on one end of the cables, near the power source, within a recessed can, or at any location along the cables.

Other embodiments allow for other means to store, tension and lock the cables independently that do not include reels which will be further discussed.

These and other features of the present invention are evident from the drawings along with the detailed description of preferred embodiments.

### BREIF DESCRIPTION OF THE DRAWINGS

FIG. 1 is an overview of a cable lighting system of a preferred embodiment of the present invention.

FIG. 2 is a rear view of the system of FIG. 1.

FIG. 3 is an exploded view of the assembly of the system of FIG. 1.

FIG. 4 is a view of a first step of mounting the system of FIG. 1.

FIG. 5 is a detail view of the cable reel mechanism of the embodiment of FIG. 1.

FIG. 6 is another detail view of the cable reel mechanism of the embodiment of FIG. 1.

FIG. 7 is another detail view of the knob of the cable reel mechanism.

FIG. 8 is another detail view of the cable reel mechanism of the embodiment of FIG. 1.

FIG. 9 is view of the operation of the cable reel mechanism of the embodiment of FIG. 1.

FIG. 10 is another detail view of the operation of the cable reel mechanism of the embodiment of FIG. 1.

FIG. 11 is cross section view of the cable reel mechanism.

FIG. 12 is a view of the second step of mounting the system of FIG. 1.

FIG. 13 is a view of mounting the cable reel housing of the system of FIG. 1.

FIG. 14 is a view of the completed system of the embodiment of FIG. 1.

FIG. 15 is a top view of the system of FIG. 14.

FIG. 16 is a perspective view of the system mounted at an angle.

FIG. 17 illustrates an alternative tensioning mechanism.

### DETAILED DESCRIPTION OF THE PREFERRED EMBODIMENTS

The present invention provides a pre-assembled low voltage cable lighting system. It is to be expressly understood that this exemplary embodiment is provided for descriptive purposes only and is not meant to unduly limit the scope of the present inventive concept. Other embodiments, and variations of the conductors or lighting fixtures of the present invention are considered within the present inventive concept as set forth in the claims herein. For explanatory purposes only, the lighting apparatus of the preferred embodiments are discussed primarily for the purposes of understanding the method of installation. It is to be expressly understood that other devices are contemplated for use with the present invention as well.

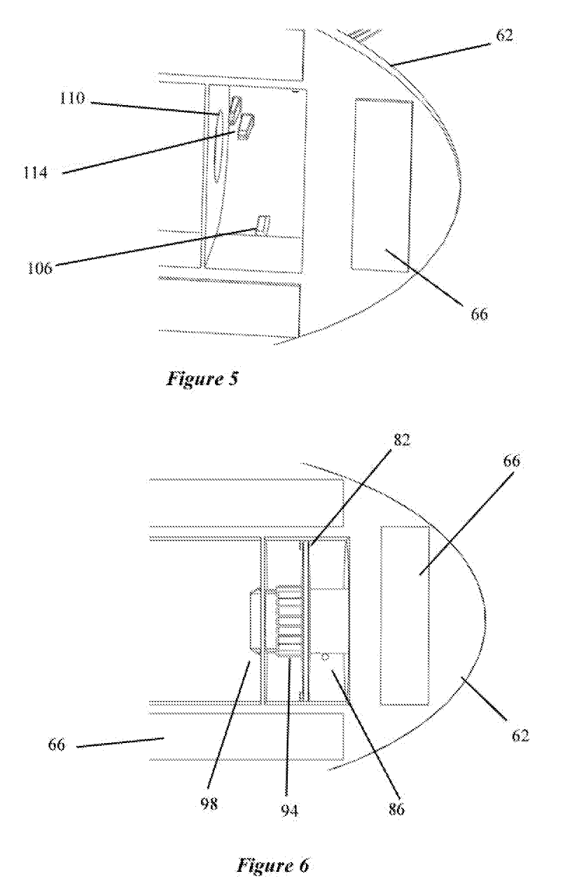

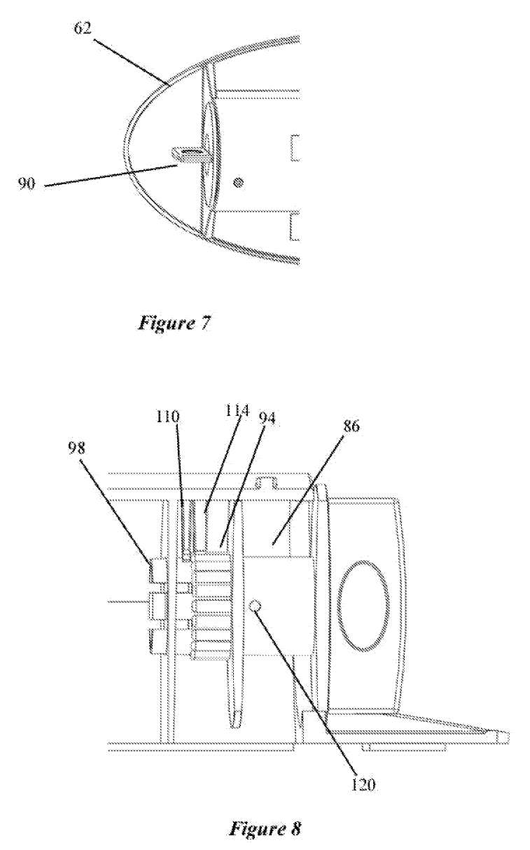

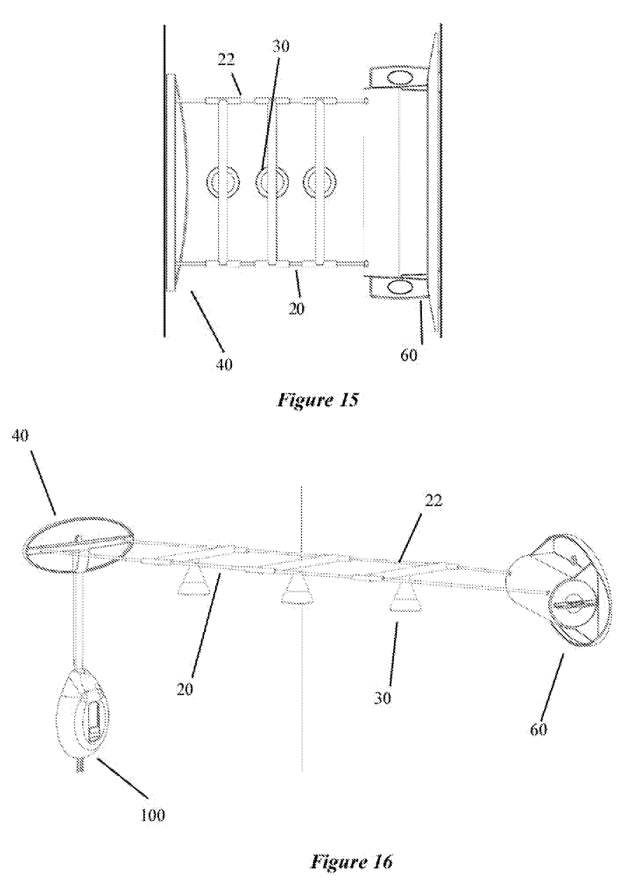

A preferred embodiment of the present system is illustrated in FIGS. 1-16. This preferred embodiment utilizes a low voltage cable lighting system 10 that comes pre-assembled and can fit most room sizes. In this preferred embodiment, the cable lighting system 10 includes two parallel braided electrically conductive cables 20, 22 that are attached to opposing, or in some instances, adjacent walls or other surfaces. It is to be expressly understood that other types, numbers and configurations of conductive cable may be used as well.

Lighting fixtures 30, such as pendants or other types of light fixtures, are secured between the electrical cables 20, 22 for support and for receiving electrical current. It is to be expressly understood that these lighting fixtures may come in any configuration, size or shape that is appropriate for low voltage lighting, particularly those designed for cable lighting systems.

The cables 20, 22 are secured on one surface by anchor plate 40 and on the other surface by cable reel mechanism 60. A transformer may be separately housed in a dimmer mechanism adjacent an electrical outlet or in other locations. Alternatively, the transformer may be housed in the anchor plate 40.

The anchor plate 40, as shown in FIG. 1, includes a plate 42 and adhesive mounting tape 44. In the preferred embodiment, the plate 42 is mounted by the adhesive mounting tape 44 as shown in FIG. 4 by a pressure application system such as the system disclosed in U.S. patent application Ser. No. 11/426,574 incorporated herein by reference. Screws may be used along with the adhesive mounting tape to ensure a secure fastening of the anchor plate. The anchor plate can be secured to the wall surface by other mounting mechanisms as well such as by a screw through screw hole 46, or by other attachment mechanisms. The mounting plate also includes holes 8 for receiving the cables 20, 22 that are secured by clamps, knots, screws or other attachment mechanisms. The cables are electrically connected to an electrical source by an adhesive mounted electrical power cord, such as the power supply disclosed in U.S. Pat. Nos. 6,540,372 and 7,137,727, incorporated herein by reference or by other conventional power supplies.

The opposing ends of cables 20, 22 are secured to other wall or surface by cable reel mechanism 60. The cable reel mechanism includes exterior housing 62. The housing 62 is mounted onto the surface by using an anchor plate 64 that is mounted to the wall surfaces by adhesive tapes 66 similar to the anchor plate 40 discussed above.

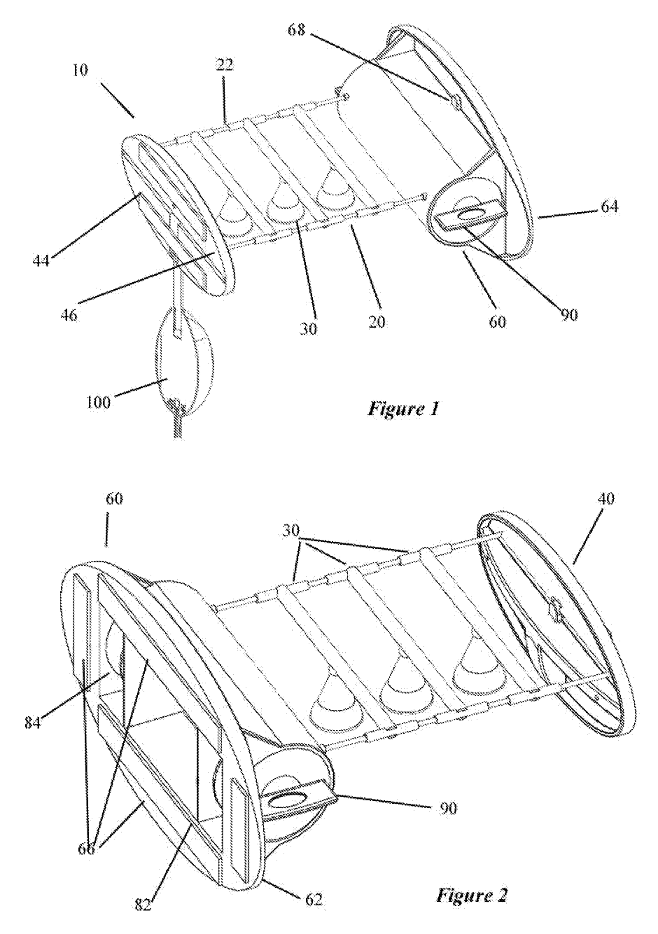

The cable reel mechanism 60 includes independent cable tightening mechanism 80 to independently tighten each of the cables 20, 22. The cable tightening mechanism 80 as shown in FIGS. 2, 3 and 5-11 includes reels 82, 84 having spools 86, 88 for winding and unwinding the cables 20, 22, respectively. The reels 82, 84 have knobs 90, 92 that extend outside the housing or by detachable or hidden knobs. The inner surface of the reels 82, 84 include ratchet mechanisms 94, 96 and clips 98, 100 respectively. The reels are inserted into openings on the sides of the housing so that the clips 98, 100 engage through the apertures in a bracket in the housing to retain the reels within the housing. The cables 20, 22 are inserted through cable holes 106, 108 and tied inside the spools 86, 88.

The housing 62 includes resilient posts 110, 112, 114, 116 formed inside the housing adjacent the ratchet mechanism 94, 96. The posts 110, 114 are adjacent one another while posts 112, 116 are adjacent one another at the other end of the housing. Knobs 90, 92 are formed on the end of the reels 82, 84 on the exterior of the housing.

When the knobs 90, 92 are pulled outward or slightly extended from the housing, the ratchet mechanisms 94, 96 engage with only the resilient posts 110, 112, respectively. This provides some friction against the ratchets 94, 96 as shown in FIGS. 8 and 11. This prevents the reels from freely unwinding the cables but allows the cables to be pulled from the reel in a relatively easy manner so the cables may be unwound during the installation process.

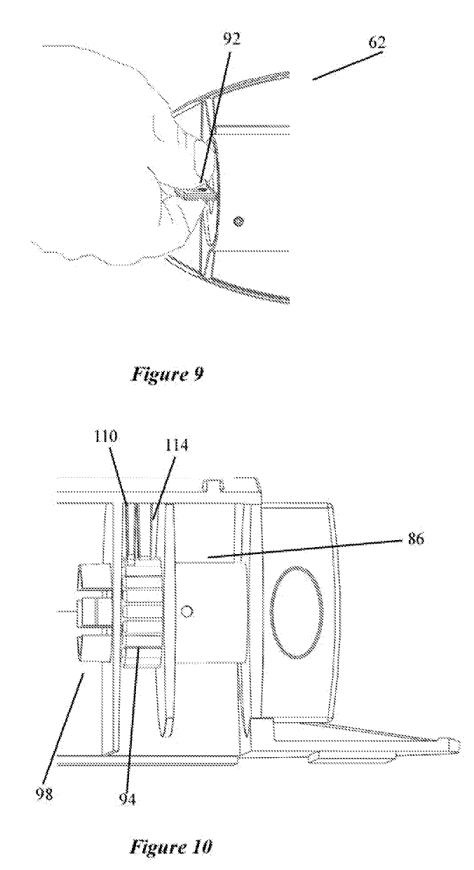

When the knobs 90, 92 are pushed inward and retained by a clicking mechanism, the toothed ratchet mechanisms 94, 96 engage with the second set of resilient posts, 114, 116 respectively to provide additional friction as shown in FIGS. 9, 10 and 11. This allows the reel to be rotated in one direction only to wind the cables onto the reels and hold it securely so the cables are taught. The holding force of the posts can be overcome with sufficient cable pulling force in the event that the cable is snagged so as not to damage the system. Each of the reels operate independently relative to one another. This allows the cable reel housing 62 to be mounted at an angle relative to the anchor plate 42 as shown in FIG. 16.

Other types of cable tightening mechanisms for the reels may be uses as well, such as coil springs, metal spring clips or any other mechanism that can apply friction to the cable in one setting and strong holding power in the other setting. In addition, a locking mechanism may be used to secure the cables that employ a cam lock, wedge lock or other locking device engaged once the cables are properly tensioned.

Other embodiments that do not use reels to hold the cables yet provide simple tensioning methods can also be used. These include but are not limited to mechanisms to coil or hold the cable so it can be let out for instillation, which might be outside the housing such as spools, loops and other means to organize the cables. These means use a locking mechanism such as a levered cam or push-in wedge to lock the cables once they are pulled tight by hand.

The cables 20, 22 are engaged with electrical contact leads that are also attached to the transformer 100. This supplies electrical current to the cables 20, 22 and thus to the light fixtures 30. The transformer may be mounted within the anchor mount 40, on the wall and held by adhesive tape, plugs into the electrical power outlet, within a recessed ceiling can, junction box or other locations.

In this preferred embodiment, lighting fixtures 30 are preinstalled onto the cables 20, 22. The fixtures can be slid along the cables to the desired locations. In other embodiments, the light fixtures can be installed after the cables are installed and tensioned.

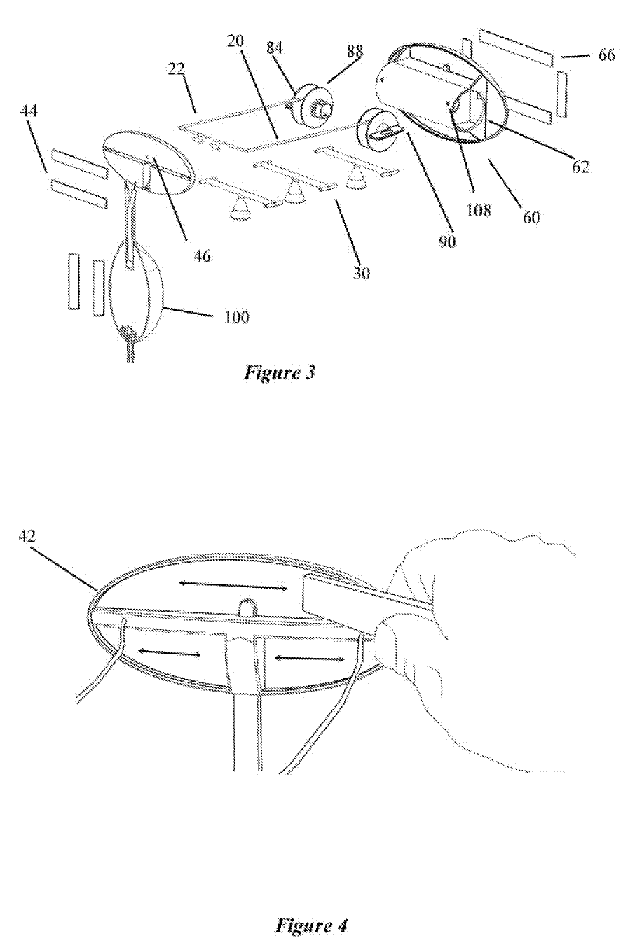

In use, the cable lighting system is attached by first securing the anchor plates 40, 66 to the wall surfaces as shown in FIG. 3. These wall surfaces can be opposing walls at any angle or even adjacent walls if there is an adequate angle. The distance between the wall surfaces is limited only by the amount of cable supplied.

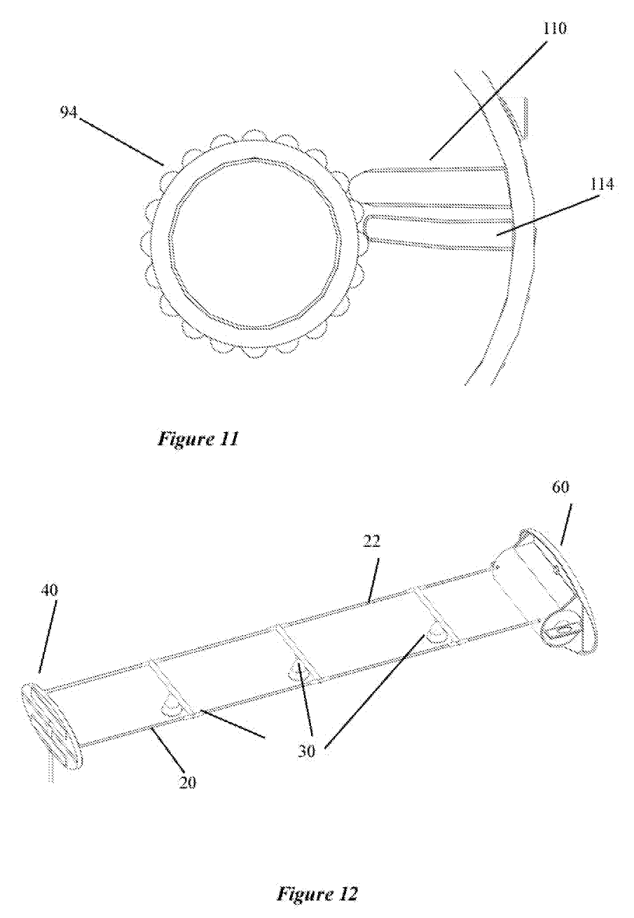

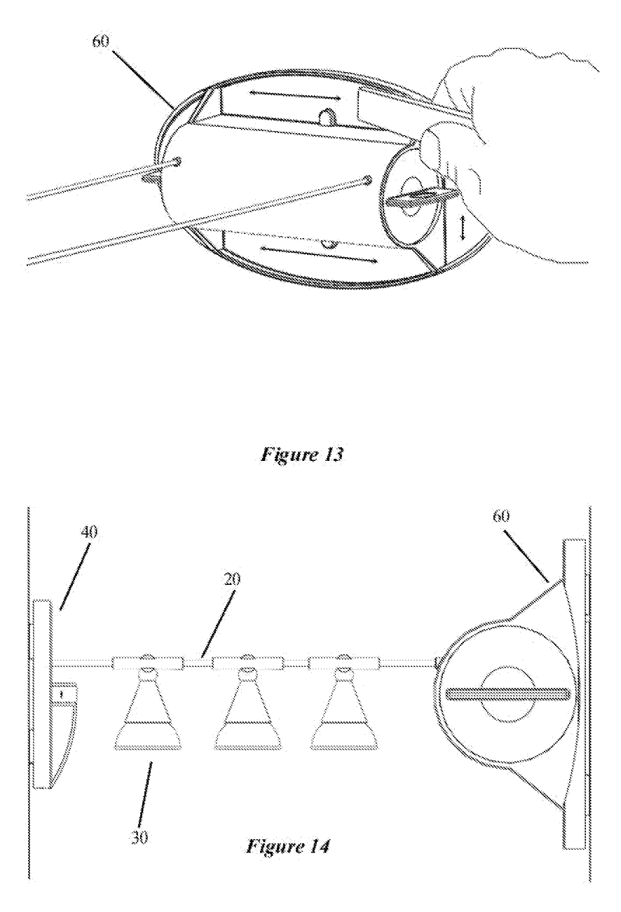

The cable reel housing is pulled away from the mounted anchor plate 40 as shown in FIG. 12. The cable reel housing 62 is then attached to the desired location on the opposing wall as shown in FIG. 13. At this time, the cables 20, 22 are under some tension but are relatively slack. The cable light fixtures 30 can then be adjusted to the desired location with the cables somewhat slack. They can also be moved when the system is under tension.

The knobs 90, 92 are then pushed inward so the stronger tensioning post is engaged and rotated to tighten the cables as shown in FIG. 9. The ratchet mechanism allows the individual cable reels to be operated so that a cable may reach the desired tension independently of the other cable. This allows the cables to be positioned so that the cables may have differing lengths, such as at an angle.

The power cord that supplies low voltage electricity is low profile, adhesive backed and attaches to the wall. It extends to a transformer with switch or dimmer installed in a housing that is adhesive mounted to the wall. It is then plugged into the electrical outlet, or plugged into a recessed ceiling can with a screw in adaptor. In other preferred embodiments, the system can be hardwired into existing junction boxes. The transformer, in one preferred embodiment, is mounted within a centrally located junction box and in other embodiments plugged directly into an electrical receptacle. The transformer can attach to the cables 20, 22 at one end or in a central location.

In a preferred embodiment of the present invention, the cable lighting system is pre-assembled and distributed in a kit form. The user simply unpacks the pre-assembled system, as shown in FIG. 1. The system may also be mounted to separate anchor plates at the desired locations, The user secures the two plaques with cables attached onto the anchor plates and tensions the cables by the use of the crank mechanism. There are little or no tools necessary and no mechanical skill is needed.

In another preferred embodiment of the present invention, the anchor plate and the cable reel housing may include plaques that are mounted to the wall by the adhesive tape and/or screws or other fasteners. The anchor plate and the cable reel housing are already pre-mounted on the cables. Once the plaques have been mounted onto the mounting surfaces, the anchor plate and the cable reel housing are simply slipped over the respective plaques and snap into place.

The above described embodiment disclosed using cables in a straight fashion. In other embodiments brackets may be used to redirect the cables around corners or in other directions. The tensioning mechanism is utilized to maintain the tension even with these brackets.

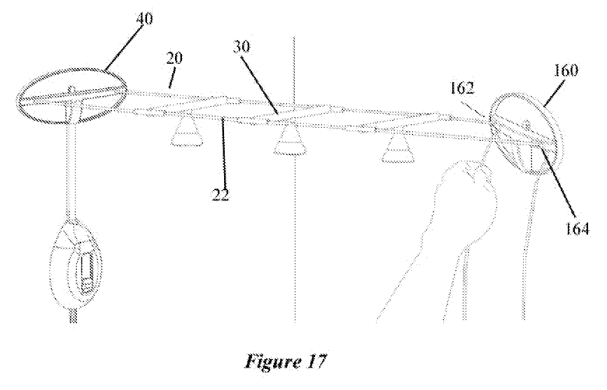

In another embodiment shown in FIG. 17, an alternative embodiment of the tensioning mechanism is illustrated. The cables 20, 22 are inserted into plate 160 that is mounted to the wall. The cables are pulled tight manually and locked into place by cord locks 162, 164. The excess cable may then be cut off or coiled and stored inside the housing.

Other tensioning mechanisms are also included within the scope of the claimed invention. It is to be expressly understood that the above described embodiments are intended for explanatory purposes and are not meant to limit the scope of the claimed inventions.

What is claimed is:

1. A method for installing a cable lighting system comprising of a preassembled system having a first cable mounting assembly, a second cable mounting assembly, two electrically conductive cables connected between said first cable mounting assembly and said second cable mounting assembly, an electrical power supply, and a power cord extending from said electrical power supply to said two electrically conductive cables and a tensioning system connected to said electrically conductive cables, said method comprising the steps of:
attaching said first cable mounting assembly to a first surface;
attaching said second cable mounting assembly to a second surface; and
adjusting the tension in said cables by operating said tensioning mechanism.

2. The method of claim 1 wherein said preassembled system includes a first adhesive backing on said first cable mounting assembly and a second adhesive backing on said second cable mounting assembly, and said method further comprises:
attaching said first cable mounting assembly by said first adhesive backing to a first surface; and
attaching said second cable mounting assembly by said second adhesive backing to a second surface.

3. The method of claim 1 wherein said system further includes a plurality of light fixtures preassembled to said two cables and said method further comprises:
adjusting the position of said light fixtures.

4. The method of claim 1 wherein said system further includes and adhesive backing on said electrical power supply and an adhesive backing on said power cord and said method further comprises:
said electrical power supply is mounted to a surface by said adhesive backing; and
said power cord is mounted to a surface by said adhesive backing.

5. The method of claim 1 wherein said system further includes a first cable reel on said tensioning mechanism and a second cable reel on said tensioning mechanism that operates independently of said first cable reel and said method further includes:
operating said tensioning mechanism so that each of said cables is adjusted to a desired tension independently on one another.

6. A pre-assembled lighting system wherein said lighting system comprises:
two conductive cables;
a first anchoring system attached to one end of said two conductive cables;
a second anchoring system attached to the other end of said two conductive cables;
an electrical supply for supplying electrical current to said two conductive cables connected to said two conductive cables;
a mechanism on said second anchoring system for creating tension on said two conductive cables of one another;
a plurality of lighting fixtures attached to said two conductive cables; and
wherein said two conductive cables, said first anchoring system, said second anchoring system, said electrical supply, said mechanism and said lighting fixtures are preassembled in a consumer package.

7. The preassembled lighting system of claim 6 wherein said preassembled lighting system further includes:
a first adhesive backing on said first anchoring system for attaching said first anchoring system to a first mounting surface; and
a second adhesive backing on said second anchoring system for attaching said second anchoring system to a second mounting surface.

8. The preassembled lighting system of claim 6 wherein said preassembled lighting system further includes:
an adhesive backing on said electrical supply to attach said electrical supply to a mounting surface;
a power cord for connecting said electrical supply to said two conductive cables; and
an adhesive backing on said power cord for attaching said power cord to a mounting surface.

9. The preassembled lighting system of claim 6 wherein said tensioning mechanism includes:
individual tensioning mechanisms for each cable to enable the tension in each cable to independently adjusted with respect to the other cable.

10. The preassembled lighting system of claim 6 wherein said tensioning mechanism includes:
two cable reels; and
attachment mechanisms attaching each of said cables to said cable reels.

11. The preassembled lighting system of claim 6 wherein said tensioning mechanism includes:
two cable reels;
a ratchet mechanism on each of said cable reels to allow said cable reels to ratchet independently with respect to the other cable reel when said cable attached to said cable reel reaches a predetermined tension.

12. The preassembled lighting system of claim 6 wherein said lighting system includes:
a first housing;
a first cable reel and second cable reel mounted in said first housing;
attachment mechanisms for attaching one of said cables to said first cable reel and for attaching the second of said cables to said second cable reel;
a first ratchet mechanism to allow said first cable reel to be rotated to spool said first cable on said first cable reel and to lock said first cable reel once the desired tension is achieved; and
a second ratchet mechanism to allow said second cable reel to be rotated to spool said second cable on said second cable reel and to lock said second cable reel once the desired tension is achieved.

13. The preassembled lighting system of claim 7 wherein said system further includes:
a pressure application system for applying pressure on said first adhesive backing and on said second adhesive backing.

14. The preassembled lighting system of claim 6 wherein said tensioning mechanism includes:
a locking mechanism for locking the tension on said cables.

15. A lighting system wherein said lighting system comprises:
two conductive cables;
a first anchoring system attached to one end of said two conductive cables;
an adhesive backing on said first anchoring system;
a second anchoring system attached to the other end of said two conductive cables;
an adhesive backing on said second anchoring system;
an electrical supply for supplying electrical current to said two conductive cables connected to said two conductive cables;
a mechanism on said second anchoring system for creating tension on said two conductive cables of one another;
a plurality of lighting fixtures attached to said two conductive cables.

16. The lighting system of claim 15 wherein said lighting system further includes:
said two conductive cables, said first anchoring system, said second anchoring system, said electrical supply, said mechanism and said lighting fixtures are preassembled in a consumer package for installation by a consumer without tools.

17. The lighting system of claim 15 wherein said lighting system further includes:
an adhesive backing on said electrical supply to attach said electrical supply to a mounting surface;
a power cord for connecting said electrical supply to said two conductive cables; and
an adhesive backing on said power cord for attaching said power cord to a mounting surface.

18. The lighting system of claim 15 wherein said tensioning mechanism includes:
individual tensioning mechanisms for each cable to enable the tension in each cable to independently adjusted with respect to the other cable.

19. The lighting system of claim 15 wherein said tensioning mechanism includes:
two cable reels; and
attachment mechanisms attaching each of said cables to said cable reels.

21. The lighting system of claim 15 wherein said tensioning mechanism includes:
two cable reels;
a ratchet mechanism on each of said cable reels to allow said cable reels to ratchet independently with respect to the other cable reel when said cable attached to said cable reel reaches a predetermined tension.

22. The lighting system of claim 15 wherein said lighting system includes:
a first housing;
a first cable reel and second cable reel mounted in said first housing;
attachment mechanisms for attaching one of said cables to said first cable reel and for attaching the second of said cables to said second cable reel;
a first ratchet mechanism to allow said first cable reel to be rotated to spool said first cable on said first cable reel and to lock said first cable reel once the desired tension is achieved; and
a second ratchet mechanism to allow said second cable reel to be rotated to spool said second cable on said second cable reel and to lock said second cable reel once the desired tension is achieved.

23. The preassembled lighting system of claim 15 wherein said system further includes:
a pressure application system for applying pressure on said adhesive backings.

24. The preassembled lighting system of claim 15 wherein said tensioning mechanism includes:
a locking mechanism for locking the tension on said cables.
